(19) United States
(12) Patent Application Publication
(10) Pub. No.: US 2014/0032581 A1
(43) Pub. Date: Jan. 30, 2014

(54) METHOD AND SYSTEM TO TRANSPARENTLY NAVIGATE RELATIONAL DATA MODELS

(71) Applicant: Jeff Young, San Jose, CA (US)

(72) Inventor: Jeff Young, San Jose, CA (US)

(21) Appl. No.: 12/573,715

(22) Filed: Oct. 5, 2009

(51) Int. Cl. G06F 17/30

(52) U.S. Cl. 707/758; 707/E17.045; 707/829

(57) ABSTRACT

A system for transparent navigation of relational data models is provided. The system may include a request detector, a relationship detector, and an address evaluator. The request detector may be configured to receive a request for a node in the data schema. The relationship detector may be configured to determine that the request includes information associated with the relationship aspect. The address evaluator may be configured to resolve the information associated with the relationship aspect into the requested node.

### TECHNICAL FIELD

This disclosure relates generally to the technical fields of software and/or hardware technology and, in one example embodiment, to a system and method to transparently navigate relational data models.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

XML (Extensible Markup Language) may be used to encode a hierarchical data model, e.g., a tree of XML elements and their attributes. Relational databases, in contrast, normally encode relational data models where 1:n, n:1 and n:n relationships are easily encoded.

While relational models can be encoded in XML where a parent element may include more than one child, a child element in the XML hierarchy cannot be designated as having more than one parent. XPath is an addressing language that may be used to point to or select certain information from an XML tree.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a subject element in a hierarchical data schema, in accordance with an example embodiment;

FIG. 2 is a block diagram showing an architecture that may be used to create hierarchical data schemas based on relational data models, in accordance with an example embodiment;

FIG. 3 is a block diagram showing an architecture that may be used to transparently navigate relational data models, in accordance with an example embodiment;

FIG. 4 is a block diagram illustrating a system to accommodate transparent navigation of relational data models, in accordance with an example embodiment;

FIG. 5 is a flow chart illustrating a method to create hierarchical data schemas based on relational data models, in accordance with an example embodiment;

FIG. 6 is a flow chart illustrating a method to process a request for a node in a hierarchical data schema, in accordance with an example embodiment; and

FIG. 7 is a diagrammatic representation of a machine in the example form of a computer system within which a set of instructions, for causing the machine to perform any one or more of the methodologies discussed herein, may be executed.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

System and method for transparent navigation of relational data models encoded as a hierarchical data model (e.g., using XML) are described. A hierarchical data model may include one or more elements, each having one or more associated aspects (e.g., attributes, references to other elements, etc.). One aspect of an element is designated as the primary key. The value of the primary key uniquely identifies the associated instance of the element. An example element defining data associated with an employee and having the “ID” attribute designated as the primary key is shown below in Table 1.

TABLE 1

```
element “employee” [contains
      attribute “ID” [primary-key],
      attribute “hr-rep-ID”,
      attribute “cost-center-number”,
      element “name”,
      element “office-number”
]
```

As shown in Table 1, the “ID” attribute of the “employee” element is designated as the primary key, such that a data node associated with a particular employee (represented by an instance of the “employee” element) can be obtained by requesting an “employee” instance associated with the certain “ID” value. The value of the “hr-rep-ID” attribute shown in Table 1 corresponds to the value of the primary key of another “employee” instance. In the example shown in Table 1, the relationship between the primary key of the “employee” element and the value of the “hr-rep-ID” is not explicitly declared. In one embodiment, the system and method for transparent navigation of relational data models encoded in XML may be configured to permit explicit declaration of relationships at the level of an element in a data model.

An example of an element that includes an explicit declaration of a relationship (as a relationship aspect) between an element and an aspect of that element is shown below in Table 2.

TABLE 2

```
element “employee” [contains
      attribute “ID” [primary-key],
      attribute “hr-rep-ID”,
      attribute “cost-center-number”,
      element “name”,
      relationship “hr-representative” [points to “employee” via
      “hr-rep-ID”],
      element “office-number”
]
```

The declaration of the relationship shown in Table 2 indicates that the value of the “hr-rep-ID” attribute of a first instance of the element can be used as the primary key to locate a second instance of the element. In this example, the “hr-representative” relationship indicates to the processing applications that there exists a relationship between two instances in of the “employee” element, where the “hr-rep-ID” attribute of one instance shares the same value as the primary key (“ID”) attribute of another instance. An instance of an element may be referred to as an XML node or merely a node. A processing application may be configured to use that information to allow an addressing language, such as XPath, to use the relationship directly. For example, a request for a node associated with an HR representative of an employee whose “ID” equals “15” may be expressed in an addressing language as follows.

data/employee[15]/hr-representative/name

In one embodiment, a relationship defined in an element may cross element types, as shown in Table 3 below.

```
TABLE 3
element “ownership-data” [contains
      element “holding” [contains
            attribute “holding-ID” [primary-key],
            element “address”
      ],
      element “person” [contains
            attribute “person-ID” [primary-key],
            attribute “principle-residence-ID”,
            element “name”
            relationship “principle-residence” [points-to “holding” via
            “principle-residence-ID”]
      ]
]
```

In the example shown in Table 3, the “ownership-data” element has two child elements: “holding” element and “person” element. The relationship explicitly defined in the “person” element indicates that there exists a relationship between an instance of the “holding” element and an instance of the “person” element, where the “principle-residence-ID” attribute of the “person” element points to the primary key (“holding-ID”) attribute of the “holding” element. A request for a node that provides information regarding John Doe's principle residence may be expressed in an addressing language as follows.

ownership-data/person[name=“John Doe”]/principle-residence/address

A relationship aspect, according to one example embodiment, can thus be declared at the level of an element (as a child of an element). In one embodiment, a relationship aspect may be described using XMLSchema. In other embodiments, a relationship aspect may be described using Relax NG (REgular LAnguage for XML Next Generation) schema. In order to differentiate between an element that includes a relationship aspect and an element to which the relationship aspect points to, the element that includes a relationship aspect may be labeled “a subject element” and the element to which the relationship aspect points to may be labeled “a related element.” A relationship aspect can be used to direct an address evaluating system, such as an XPath processor, to treat a value of an attribute of a subject element as a value of the primary key of the related element. The type of the related element may be the same as the type of the subject element, e.g., as shown in Table 2, where the type of the related element is “employee” and the type of the subject element is also “employee.” The type of the related element may also be different from the type of the subject element, e.g., as shown in Table 3, where the type of the related element is “holding” and the type of the subject element is “person.”

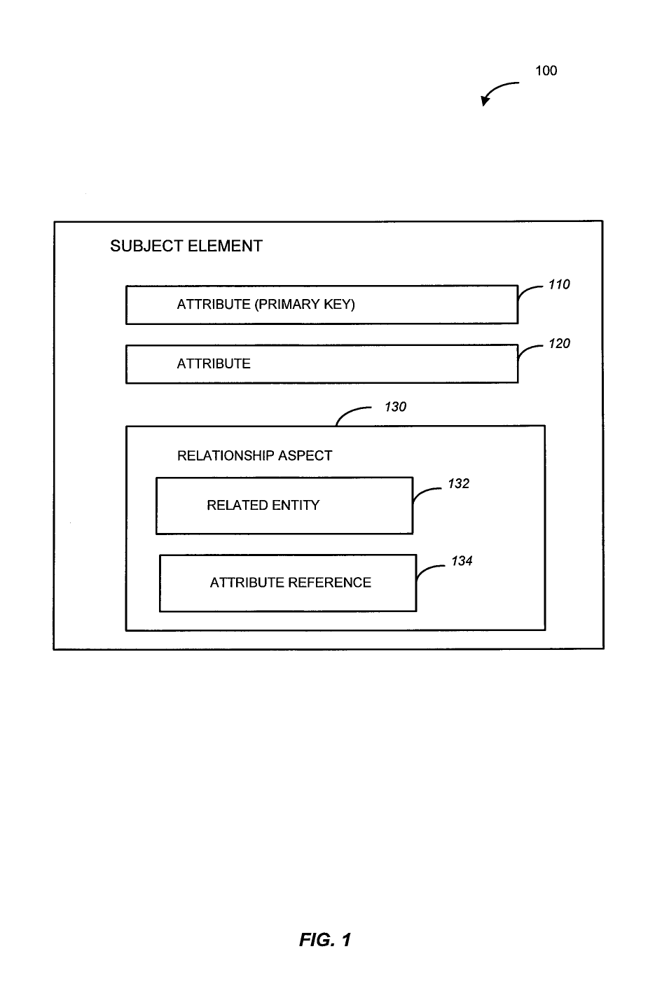

An example subject element 100 is shown in FIG. 1. As shown in FIG. 1, the subject element 100 includes an attribute 110 that is designated as the primary key, an attribute 120, and a relationship aspect 130. The relationship aspect 130 designates a relationship between a related entity 132 and an attribute reference 134. The attribute reference 134 may reference, e.g., the attribute 120.

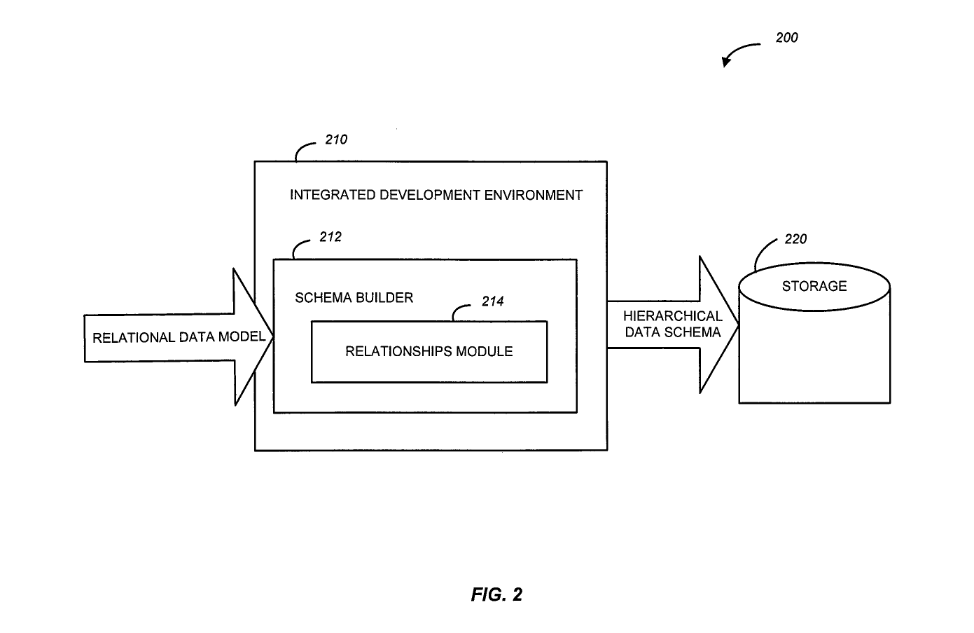

An example architecture that may be used to create hierarchical data schemas based on relational data models may be described with reference to FIG. 2. FIG. 2 shows an architecture 200 that includes a schema builder 212 provided in an integrated development environment (IDE) 210. The schema builder 212 is shown to include a relationships module 214. The relationships module 214 may be configured to add explicit definitions of relationships into elements in a hierarchical data schema that was created based on a relational data model. Also shown in FIG.2 is a storage component 220 that may be used to store an in-memory representation of the hierarchical data schema.

The architecture 200 may be implemented in the context of a network environment, e.g., where a relation data model is provided to the schema builder 212 using a communications network. A communications network may be a public network (e.g., the Internet, a wireless network, a public switched telephone network (PSTN), etc.) or a private network (e.g., LAN, WAN, Intranet, etc.). A communications network may also be used to communicate an in-memory representation of a hierarchical data schema to the storage component 220.

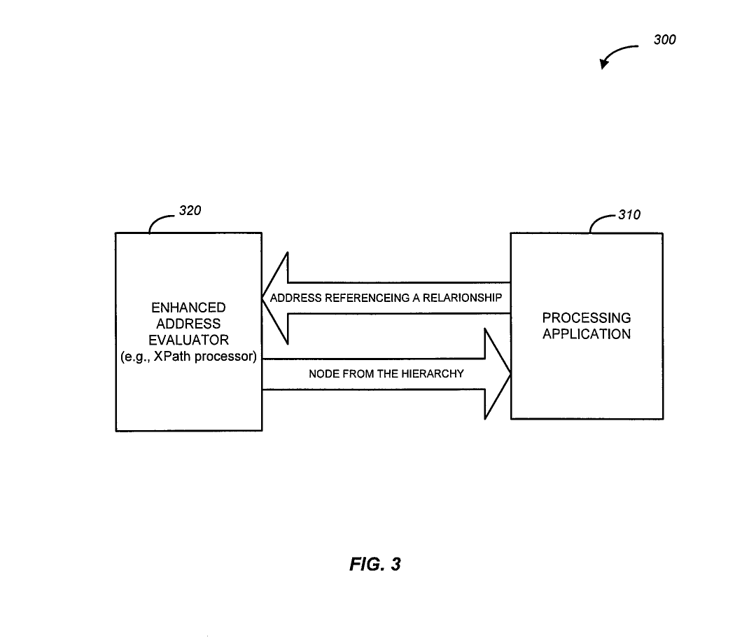

FIG. 3 is a block diagram showing an architecture 300 that may be used for transparent navigation of relational data models. Shown in FIG. 3, is a processing application 310 that may be configured to issue requests for particular nodes in a data hierarchy and to receive information associated with the requested node. An enhanced address evaluator 320 (such as, e.g., an enhanced XPath processor), in one embodiment, is configured to determine that a request for a node includes an explicit relationship information and use that information to resolve the node to which the relationship is pointing.

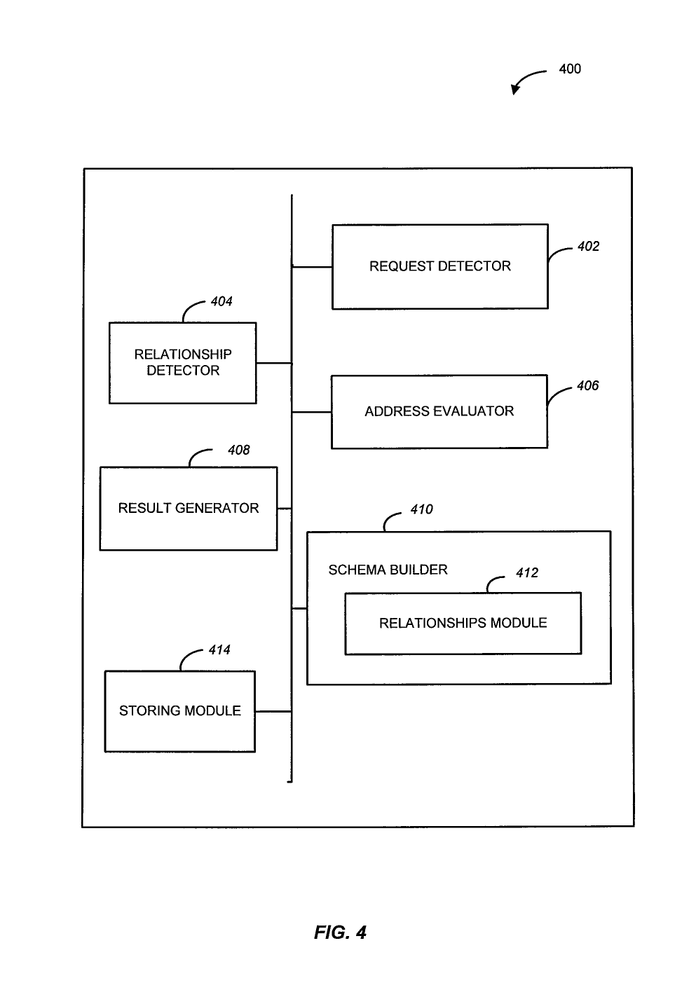

An example architecture 200 for transparent navigation of relational data models may be discussed with reference to FIG. 2. The architecture 200 is shown as including some modules that may be provided in the IDE 210 of FIG.2, some modules that may be part of the enhanced address evaluator 320 of FIG. 3, as well as modules that may be provided elsewhere in a computing system. The modules illustrated in FIG. 4 may be implemented as software, hardware, or a combination of both. As shown in FIG. 4, the system 400 comprises a request detector 402, a relationship detector 404, an address evaluator 406, and a result generator 408. The request detector 402 may be configured to receive a request for a node in the data schema. The request may be issued by a processing application and may be expressed in an addressing language such as XPath. As mentioned above, an example request for a node that corresponds to the name of an employee who is an HR representative of an employee whose “ID” equals “15” may be expressed in an addressing language “data/employee[15]/hr-representative/name.”

The relationship detector 404 may be configured to determine that the request includes information associated with the relationship aspect. In the example above, the relationship detector 404 may recognize that the “hr-representative” is the name of a relationship aspect. The address evaluator 406 may be configured to resolve the information associated with the relationship aspect into the requested node. The system 400 may also include a result generator 408 configured to provide data associated with the node resolved by the address evaluator 406 to the processing application.

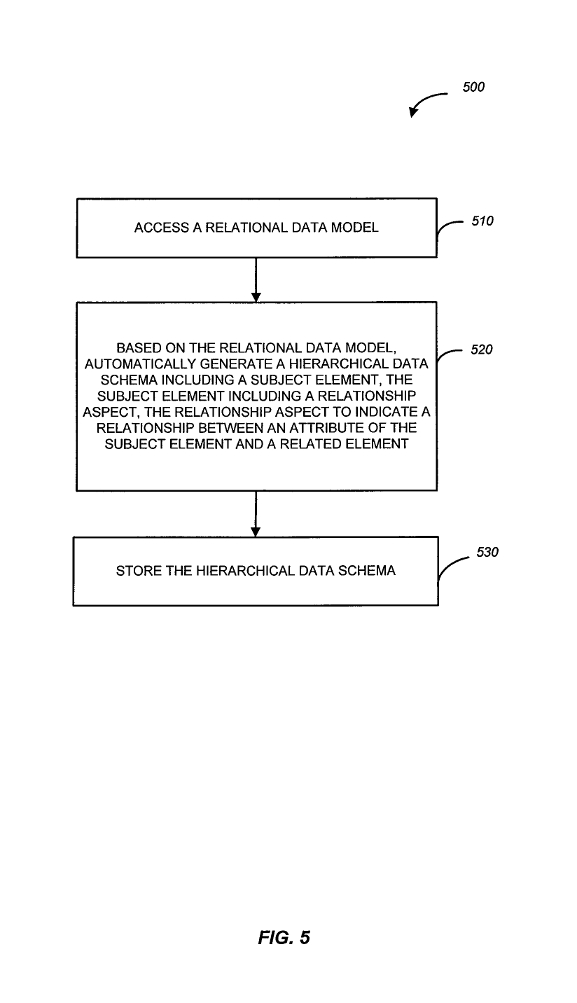

Also shown in FIG. 4 are a schema builder 410 with an associated relationships module 412 and a storing module 414. In one embodiment, the schema builder 410 and the relationships module 412 may correspond respectively to the schema builder 212 and the relationships module 214 of FIG. 2. As described above, with reference to FIG. 2, the relationships module 412 may be utilized to add explicit definitions of relationships into elements in a hierarchical data schema. A storing module 414 may be configured to store, in a memory device, data schemas created by the schema builder 410 or data schemas receives from other computing systems. Various operations performed by the system 400 with respect to creating a data schema, according to an example embodiment, may be discussed with reference to FIG. 5.

FIG. 5 is a flow chart illustrating a method 500 for transparent navigation of relational data models, in accordance with an example embodiment. The method 500 may be performed by processing logic that may comprise hardware (e.g., dedicated logic, programmable logic, microcode, etc.), software (such as run on a general purpose computer system programmed to perform particular functions pursuant to instructions from program software or on a dedicated machine), or a combination of both. The processing logic, according to example embodiments, may reside in any of the modules shown in FIG. 4. Alternative embodiments may comprise more, less, or functionally equivalent modules or engines in various combinations. While certain modules or engines are described as performing certain operations, these descriptions are merely examples and the operations may be performed by other components or systems.

As shown in FIG. 5, the method 500 commences with operation 510, where the schema builder 410 of FIG. 4 accesses a relation data model and automatically generates a hierarchical data schema (e.g., an XML schema) based on the relational data model at operation 520. The generated hierarchical data schema may comprise a subject element that includes an explicitly defined relationship aspect. As explained above, a relationship aspect indicates a relationship between an attribute of the subject element and a related element, where the related element may be the same element as the subject element (as shown above in Table 2) or an element that is distinct from the subject element (as shown above in Table 3).

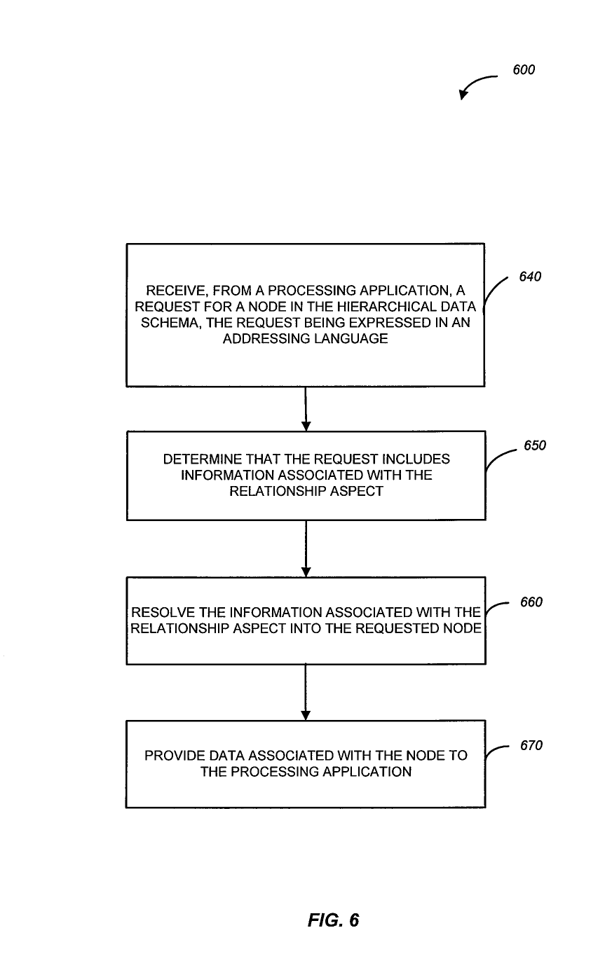

At operation 530, the storing module 414 of FIG. 4 stores the hierarchical data schema generated by the schema builder 410 in a memory device (e.g., such as the storage component 220 of FIG. 2). Various operations performed by the system 400 with respect to processing a request for a specific node in a data schema, according to an example embodiment, may be discussed with reference to FIG. 6.

FIG. 6 is a flow chart illustrating a method 600 for transparent navigation of relational data models, in accordance with an example embodiment. The method 600 may be performed by processing logic that may comprise hardware (e.g., dedicated logic, programmable logic, microcode, etc.), software (such as run on a general purpose computer system programmed to perform particular functions pursuant to instructions from program software or on a dedicated machine), or a combination of both. The processing logic, according to example embodiments, may reside in any of the modules shown in FIG. 4. Alternative embodiments may comprise more, less, or functionally equivalent modules or engines in various combinations. While certain modules or engines are described as performing certain operations, these descriptions are merely examples and the operations may be performed by other components or systems.

As shown in FIG. 6, the method 600 commences with operation 640, where the request detector 402 of FIG. 4 receives, from a processing application, a request for a node in the data schema. As mentioned above, the request may be expressed in an addressing language such as XPath. At operation 650, the relationship detector 404 of FIG. 4 determines that the request includes information associated with the relationship aspect. At operation 660, the address evaluator 406 of FIG. 4 resolves the information associated with the relationship aspect into the requested node. The requested node is provided to the processing application at operation 670.

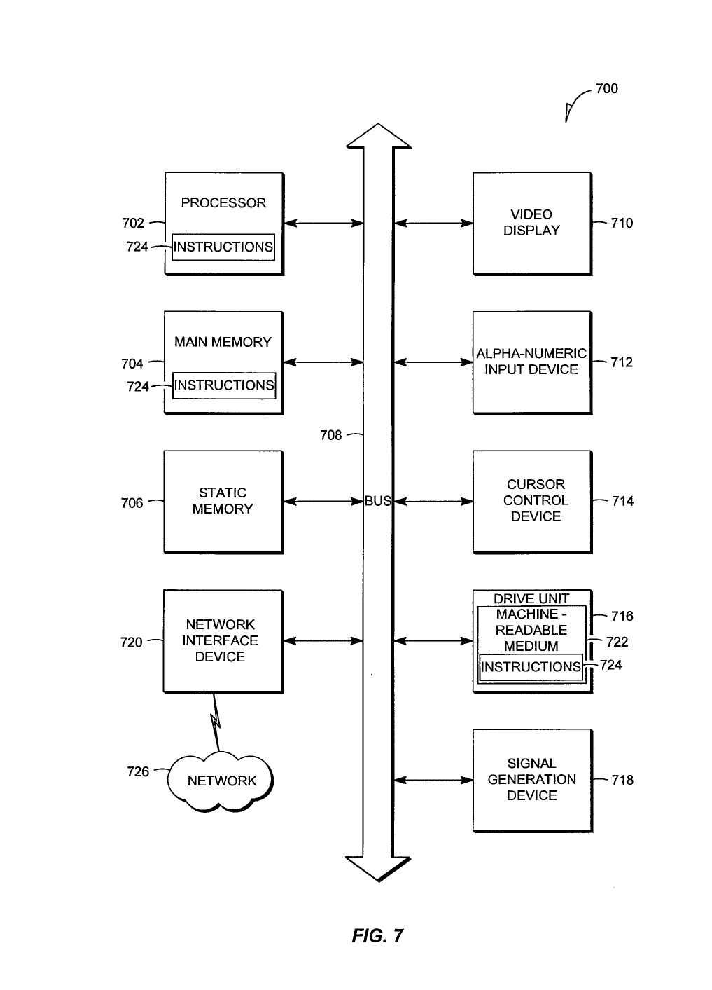

FIG. 7 is a diagrammatic representation of a machine in the example electronic form of a computer system 700 within which a set of instructions, for causing the machine to perform any one or more of the methodologies discussed herein, may be executed. In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an “Moving Picture Experts Group (MPEG) Layer 3” (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) cursor control device 714 (e.g., a mouse), a disk drive unit 716, a signal generation device 718 (e.g., a speaker) and a network interface device 720.

The disk drive unit 716 includes a computer-readable (or machine-readable) medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the methodologies of the present invention, or that is capable of storing or encoding data structures utilized by or associated with such a set of instructions. The term “machine-readable medium” shall accordingly be taken to include, but not be limited to, solid-state memories, optical and magnetic media. Such medium may also include, without limitation, hard disks, floppy disks, flash memory cards, digital video disks, random access memory (RAMs), read only memory (ROMs), and the like.

Thus, method and system for transparent navigation of relational data models have been described. While some example approaches described herein may be used with ADOBE® products, the techniques described herein may be utilized beneficially with various other products.

The embodiments described herein may be implemented in an operating environment comprising software installed on a computer, in hardware, or in a combination of software and hardware. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
storing, in a memory device, a hierarchical data schema including a subject element, the subject element including a relationship aspect, the relationship aspect to indicate a relationship between an attribute of the subject element and a related element;
receiving, from a processing application, a request for a node in the hierarchical data schema, the request being expressed in an addressing language;
identifying that the request includes information associated with the relationship aspect; and
resolving the information associated with the relationship aspect into the requested node.

2. The method of claim 1, further comprising providing data associated with the node to the processing application.

3. The method of claim 1, wherein the receiving of the request for the node includes network communications.

4. The method of claim 1, wherein the related element is of a type that is the same as a type of the subject element.

5. The method of claim 1, wherein the related element is of a type that is different from a type of the subject element.

6. The method of claim 1, comprising generating the hierarchical data schema based on a relational data model.

7. The method of claim 1, wherein the relationship aspect is described using RelaxNG schema.

8. The method of claim 1, wherein the relationship aspect is described using XMLSchema.

9. The method of claim 1, wherein the addressing language is XPath.

10. The method of claim 1, wherein the relationship aspect indicates that the attribute of the subject element corresponds to a primary key attribute of the related element.

11. A computer-implemented system comprising:
a storing module to store, in a memory device, a hierarchical data schema including a subject element, the subject element including a relationship aspect, the relationship aspect to indicate a relationship between an attribute of the subject element and a related element;
a request detector to receive, from a processing application, a request for a node in the hierarchical data schema, the request being expressed in an addressing language;
a relationship detector to identify that the request includes information associated with the relationship aspect; and
an address evaluator to resolve the information associated with the relationship aspect into the requested node.

12. The system of claim 11, comprising a result generator to provide data associated with the node to the processing application.

13. The system of claim 11, wherein the request detector and the processing application are in communication over a network.

14. The system of claim 11, wherein the related element is of a type that is the same as a type of the subject element.

15. The system of claim 11, wherein the related element is of a type that is different from a type of the subject element.

16. The system of claim 11, wherein the relationship aspect is described using Relax NG schema.

17. The system of claim 11, wherein the relationship aspect is described using XMLSchema.

18. The system of claim 11, wherein the addressing language is XPath.

19. The system of claim 11, wherein the relationship aspect indicates that the attribute of the subject element corresponds to a primary key attribute of the related element.

20. A machine-readable non-transitory storage medium having instruction data to cause a machine to:
access a relational data model;
based on the relational data model, automatically generate a hierarchical data schema including a subject element, the subject element including a relationship aspect, the relationship aspect to indicate a relationship between an attribute of the subject element and a related element; and
store the hierarchical data schema.
